(19) United States
(12) Patent Application Publication
(10) Pub. No.: US 2020/0385255 A1
(43) Pub. Date: Dec. 10, 2020

(54) Control System for a Mobile Lift Device

(71) Applicant: Warner Electric Technology LLC, Braintree, MA (US)

(72) Inventors: Mathieu Christian Michel Ruault, Villeveque (FR); Eric René Robert Volant, Denée (FR); Silvain Fauriaux, Strasbourg (FR); Jérémy Gérard Marie Raimbault, Cherry Valley, IL (US)

(21) Appl. No.: 16/434,822

(22) Filed: Jun. 7, 2019

(51) Int. Cl. B66F 9/24; B66F 9/07; B66F 9/075

(52) U.S. Cl. CPC B66F 9/24; B66F 9/072; B66F 11/04; B66F 9/07572; B66F 9/07509

(57) ABSTRACT

A mobile lift device includes a body supported on a driven wheel and a lift supported by the body and configured for vertical movement relative to the body. The lift is configured to support a load. An electric drive motor is configured to cause rotation of the driven wheel and a drive motor brake is coupled to the motor. An electromechanical linear actuator is configured to raise and lower the lift and includes an electric actuator motor. A controller is configured to determine the weight of the load. In one embodiment, the controller determines the weight by determining a level of current required by the electric actuator motor. The controller controls at least one of the electric drive motor and the drive motor brake responsive to the weight of the load.

### BACKGROUND OF THE INVENTION

### a. Field of the Invention

This disclosure relates to mobile lift devices such as forklifts and aerial work platforms. In particular, the instant disclosure relates to a control system for mobile lift devices in which braking of a driven wheel of the device is controlled in response to the weight of a load on the device that is determined in response to a signal from an electromechanical linear actuator controlling elevation of a lift of the device.

### b. Background Art

Conventional mobile lift devices include systems that control movement of the mobile lift device along a floor or ground as well as systems that control elevation of a lift of the device. Many conventional devices employ combustion engines to generate movement of the mobile lift device along a floor or ground and hydraulic or pneumatic actuators to control elevation of a lift on the device. In recent years, however, there has been a movement towards electrification of these systems. In particular, newer mobile lift devices frequently employ one or more electric motors to move the device along a floor or ground. Braking of the device is controlled through regenerative braking using the electric motors and through application of one or more brakes. Newer mobile lift devices also frequently employ an electromechanical linear actuator to control elevation of the lift. The use of electromechanical linear actuators has several advantages relative to hydraulic or pneumatic actuators. Electromechanical linear actuators are not subject to failure resulting from fluid leakage. Electromechanical actuators also do not require the use of fluid conduits between elements of the control system for the lift and the labor to connect the conduits. Electromechanical actuators are not subject to variation in operation as a result of changes in temperature which may change the viscosity of fluids. Finally, electromechanical actuators can raise and lower the lift at more consistent speeds whereas hydraulic and pneumatic actuators often produce variable speeds resulting from changes in fluid pressure.

In mobile lift devices that employ electric motor(s) and brake(s) to control movement of the device along the floor or ground, the brakes are typically configured to meet several requirements including maintaining the position of the lift device on an incline in the event of a loss of power and halting movement of the lift device on the floor or ground over a predetermined stopping distance in the event of a loss of power. The brakes are configured, however, to meet worst case scenarios in which the lift on the mobile lift device carries a load having a predetermined maximum allowed weight. As a result, when the lift on the device is not carrying a load or carrying a load having a relatively low weight, the brakes can generate far more torque than is necessary leading to rapid deceleration of the mobile lift device and a risk that the device will tilt, skid or otherwise lose control.

The inventor herein has recognized a need for a mobile lift device and a control system for a mobile lift device that will minimize and/or eliminate one or more of the above-identified deficiencies.

### BRIEF SUMMARY OF THE INVENTION

A mobile lift device and a control system for a mobile lift device are provided. In particular, a control system controls braking of a driven wheel in the device in response to the weight of a load on the device that is determined in response to a signal from an electromechanical linear actuator controlling elevation of a lift of the device.

A mobile lift device in accordance with one embodiment includes a body supported on a driven wheel and a lift supported by the body and configured for vertical movement relative to the body. The lift is configured to support a load. The device further includes an electric drive motor configured to cause rotation of the driven wheel and a drive motor brake coupled to the electric drive motor. The device further includes an electromechanical linear actuator configured to raise and lower the lift. The electromechanical linear actuator includes an electric actuator motor. The device further includes a controller configured to determine a weight of the load responsive to a signal generated by the electromechanical linear actuator. The controller is further configured to control at least one of the electric drive motor and the drive motor brake responsive to the weight of the load.

A control system for a mobile lift device in accordance with one embodiment includes an electromechanical linear actuator configured to raise and lower a lift of the mobile lift device. The lift is configured to support a load. The electromechanical linear actuator includes an electric actuator motor. The system further includes a controller configured to determine a weight of the load responsive to a signal generated by the electromechanical linear actuator. The controller is further configured to control at least one of an electric drive motor configured to cause rotation of a driven wheel of the mobile lift device and a drive motor brake coupled to the electric drive motor responsive to the weight of the load.

A mobile lift device and control system for a mobile lift device in accordance with the present teachings is advantageous relative to conventional mobile lift devices and control systems. In particular, the inventive lift device and control system use a signal generated by the electromechanical linear actuator as an indicator of the weight of the load in order to provide improved control of braking for the driven wheel of the mobile lift device. As a result, the braking torque can be varied based on the load and improved control of the mobile lift device during braking is obtained.

The foregoing and other aspects, features, details, utilities, and advantages of the present teachings will be apparent from reading the following description and claims, and from reviewing the accompanying drawings.

### BRIEF DESCRIPTION OF THE DRAWINGS

FIG. 1 is a diagrammatic view of a mobile lift device and a control system for a mobile lift device in accordance with one embodiment of the present teachings.

FIG. 2 is a diagrammatic and partial cross-sectional view of one embodiment of an electromechanical linear actuator of the mobile lift device and control system of FIG. 1.

FIG. 3 is a diagrammatic view of a control system for a mobile lift device in accordance with another embodiment of the present teachings.

### DETAILED DESCRIPTION OF EMBODIMENTS OF THE INVENTION

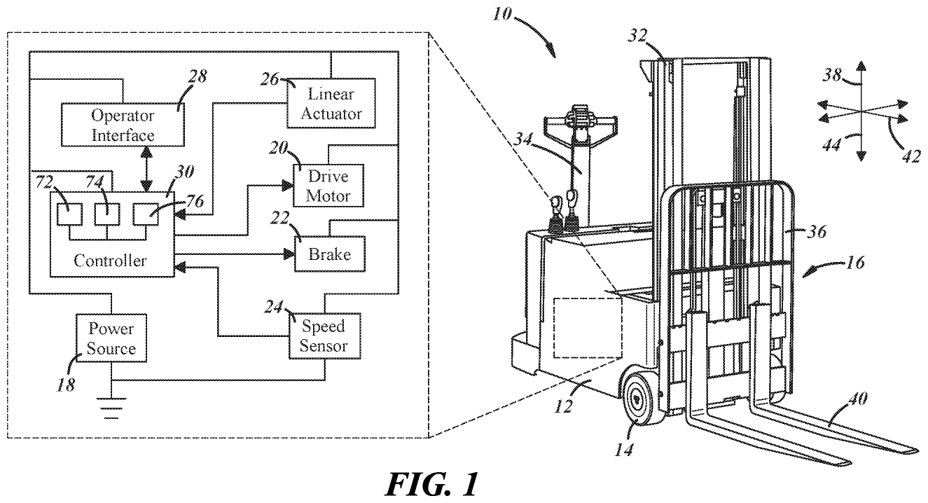

Referring now to the drawings wherein like reference numerals are used to identify identical components in the various views, FIG. 1 illustrates a mobile lift device 10 in accordance with one embodiment of the present teachings. Device 10 is provided to raise and lower various loads. In the illustrated embodiment, device 10 comprises a walk-behind or pedestrian operated forklift (sometimes known as a “walkie”). It should be understood, however, that device 10 may assume a variety of forms including forklifts in which the operator rides on and drives the forklift and other types of lift devices such as aerial work platforms. Device 10 includes a body 12, wheels 14, means, such as lift 16, for supporting a load, a power source 18, means, such as one or more drive motors 20, for causing rotation of wheels 14 and movement of device 10 along a floor or the ground, means, such as one or more drive motor brakes 22, for braking drive motors 20, means, such as speed sensor 24, for determining the rotational speed of wheels 14, means, such as one or more linear actuators 26, for raising and lowering lift 16, an operator interface 28, and means, such as controller 30, for controlling the operation of components of device 10 including motors 20, brakes 22 and actuators 26.

Body 12 is provided to support, position and orient the other components of device 10. Body 12 may include a frame for mounting exterior components such as wheels 14, lift 16, speed sensor 24 and interface 28 and may define an enclosed space configured to house interior components such as power source 18, drive motors 20, motor brakes 22, linear actuators 26, and controller 30. Body 12 may be made from conventional metals and/or plastics and may include multiple members coupled together through conventional fasteners such as screws, bolts, welds and/or adhesives. In the illustrated embodiment, body 12 includes a mast 32 or frame supporting lift 16. Body 12 also includes a handle 34 through which an operator may steer device 10.

Wheels 14 are provided to support body 12 and allow movement of device 10 along a floor or ground. At least one wheel 14 comprises a driven wheel that rotates in response to torque generated by drive motor 20 and that may be braked by the operation of drive motor 20 (through regenerative braking) and/or drive motor brake 22. One or more wheels 14 may also comprise caster wheels that are not driven by drive motor 20 but which allow rolling and rotational movement of body 12. In certain embodiments, device 10 may include wheel brakes (not shown) for braking any caster wheels on device 10 that operate under the control of controller 30. Depending on the type of mobile lift device 10, device 10 may further include outriggers or other mechanisms for balancing device 10.

Lift 16 provides a means for supporting a load. The load may comprise an empty or loaded pallet or an object. In certain embodiments, the load may comprise one or more persons (e.g., where device 10 comprises an aerial work platform). Lift 16 is supported by body 12 and is configured for vertical movement relative to body 12 under the control of linear actuators 26. In the illustrated embodiment, lift 16 includes a carriage assembly 36 that is supported on mast 32 and configured for transverse (vertical) movement relative to mast 32 along axis 38 under the control of linear actuators 26. Lift 16 further includes a pair of forks 40 supported on carriage assembly 36 to support the load. In addition to vertical movement along axis 38, carriage assembly 36 may support for-aft movement of forks 40 relative to mast 32 along axis 42 (“reach”), sideways movement relative to mast 32 along axis 44 and rotational movement about one or more of axes 38, 42, 44. The position of lift 16 along and/or about axes 38, 42, 44 may be measured using position sensors that output position signals to controller 30.

Power source 18 provides power, in the form of electrical current, to other components of device 10 including drive motor 20, motor brakes 22, speed sensor 24, linear actuators 26, operator interface 28 and controller 30. Power source 18 may comprise a battery or another conventional energy storage device such as a capacitor.

Drive motors 20 provide a means for causing rotation of wheels 14 and moving device 10 along a floor or the ground. Drive motors 20 may also provide a means for braking rotation of wheels 14 through regenerative braking. It should be understood that the number of motors 20 will vary depending on the type of device 10 and the number of driven wheels 14 on device 10. Each motor 20 comprises an electric motor such as an alternating current motor with a stator and rotor or a brushed or brushless direct current motor. An output shaft of motor 20 may be coupled to an axle supporting one or more wheels 14 through a gear train or another conventional manner. When movement of device 10 is desired, motor 20 causes rotation of wheels 14 in a rotational direction. When braking of device 10 is desired, motor 20 resists further rotation of wheels 14 in that rotational direction and converts the kinetic energy of device 10 into potential energy that may be stored in power source 18.

Drive motor brakes 22 are provided to apply a braking torque to motors 20 and, indirectly, to wheels 14. It should be understood that the number of brakes 22 may vary depending, in part, on the number of drive motors 20 in device 10. Brakes 22 may comprise electric brakes and, in some embodiments, electromagnetic brakes. Brakes 22 may also comprise fluid (hydraulic or pneumatic) brakes. In one embodiment, brakes 22 may comprise spring-set, electromagnetically released brakes that function as an emergency or parking brake. Each brake 22 may, for example, include a friction plate coupled to a shaft of motor 20 and configured for rotation with the shaft, an armature that is biased towards engagement with the friction plate by one or more springs to apply the brake 22 and an electromagnet that, when current is provided to the electromagnet, urges the armature away from the friction plate against the biasing force of the springs to release the brake 22. One of both of the friction plate and armature may include a brake pad made from conventional friction materials. Although an exemplary spring-set, electromagnetically release brake has been described above, in should be understood that brakes 22 may assume a variety of forms including, for example, electromagnetically set, spring-released brakes and brakes employing permanent or residual magnetism to apply and/or release the brake—each of which may be used to implement proportional or service braking of motors 20 as an alternative to, or in addition to, emergency or parking brake functionality.

Speed sensor 24 provides a means for determining the rotational speed of a wheel 14. Sensor may employ either a magneto-resistive or magneto-inductive operating principle and may comprise, for example a Hall effect sensor or a variable reluctance sensor. Sensor 24 may generate a speed signal indicative of a rotational speed of the driven wheel 14 and provide that signal to controller 30 along a conventional communications bus in device 10. Sensor 24 may measure the rotational speed of the driven wheel 14 directly or indirectly through, for example, the rotational speed of an output shaft of a corresponding drive motor 20.

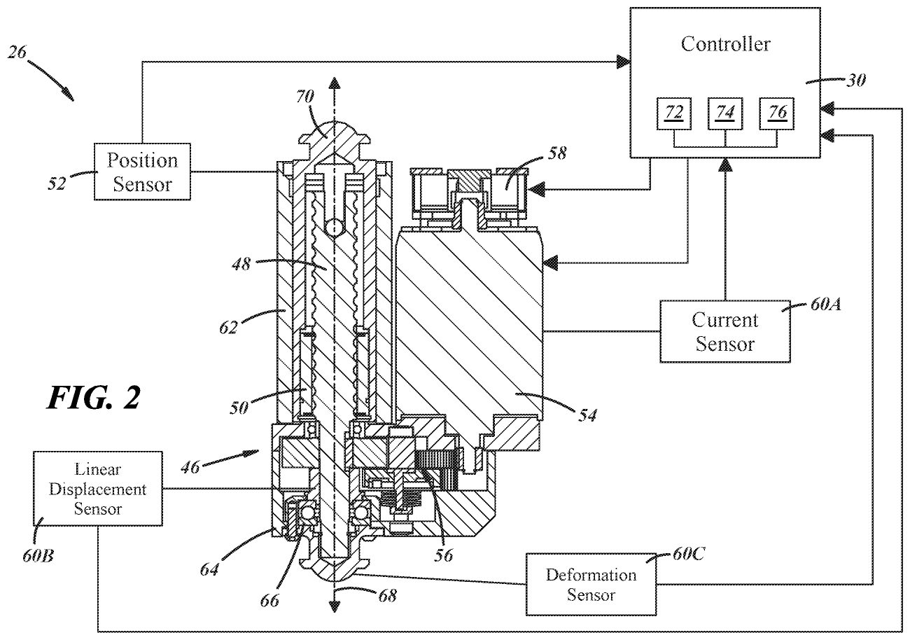

Linear actuators 26 provides a means for raising and lowering lift 16 along axis 38. It should be understood that the number of actuators 26 may vary depending on the type of device 10 and anticipated loads to be lifted by the device 10. In accordance with one aspect of the present teachings, actuators 26 comprise electromechanical linear actuators. Referring now to FIG. 2, in one embodiment an actuator 26 may include a housing 46, a screw 48, a nut 50, position sensors 52, an actuator motor 54, a gear train 56, and an actuator brake 58. In accordance with one aspect of the present teachings, actuator 26 may further include means, such as a current sensor 60A, a linear displacement sensor 60B or a deformation sensor 60C, for generating a signal indicative of the weight of a load on lift 16.

Housing 46 provides structural support to other components of actuator 26 and prevents damage to those components from foreign objects and elements. Housing 46 may include multiple members 62, 64. In the illustrated embodiment, member 62 comprise an outer tube housing a portion of screw 48 and nut 50 while member 64 houses another portion of screw 48 and gear train 56. Screw 48 may be supported for rotation within member 64 of housing 46 by bearings 66.

Screw 48 and nut 50 convert rotary motion of actuator motor 54 and gear train 56 to linear motion. Screw 48 comprises a threaded shaft configured for rotation about axis 68 (which may run parallel to axis 38 in FIG. 1). In some embodiments, screw 48 may comprise a ball screw or roller screw defining a plurality of helical inner raceways on which a set of ball bearings or rollers are supported. Nut 50 defines a plurality of helical outer raceways on which the set of ball bearings or rollers are supported. In the case of a ball screw actuator, nut 50 also defines one or more recirculation paths (not shown) for the balls. The recirculation paths may allow the balls to move from one axial end of ball nut 50 to an opposite axial end of ball nut 50. Alternatively, the recirculation paths may allow the balls to circulate along one thread or a subset of threads. Nut 50 is coupled to a rod 70 that may be in turn be connected to carriage assembly 36 of lift 16. Upon rotation of screw 48 in one rotational direction about axis 68, nut 50 and rod 70 move along axis 68 to extend rod 70 outward from housing 46 and move lift 16 along axis 38 to raise lift 16. Upon rotation of screw 48 in the opposite rotational direction about axis 68, nut 50 and rod 70 move along axis 68 to retract rod 70 into housing 46 and move lift 16 along axis 38 in the opposite direction to lower lift 16.

Position sensors 52 are provided to indicate the position of components within actuator 26. Position sensors 52 may indicate the linear position of a component of actuator 26 and may, for example, determine when the nut 50 or rod 70 has reached a predetermined position such as the maximum stroke length of actuator 26 during extension or retraction. Alternatively, position sensors 52 may indicate the rotational position of a component of actuator 26 such as screw 48 or a rotating component of motor 54 or gear train 56. In some embodiments, position sensors 52 may comprise, for example, potentiometers or linear non-contact sensors including Hall effect sensors. In one embodiment, position sensors 52 may comprise limit switches that are actuated in response to movement of the nut 50 or rod 70. In particular, when the nut 50 or rod 70 reaches a predetermined position, the state of the limit switch changes and the switch generates a signal that is transmitted to controller 30 indicating that the nut 50 or rod 70 is located at the predetermined position. In response, controller 30 controls delivery of current to actuator motor 54 and/or actuator brake 58. For example, if the position sensor 52 indicates that the nut 50 or rod 70 has reached maximum stroke length, controller 30 may terminate operation of actuator motor 54 and/or apply actuator brake 58.

Actuator motor 54 is provided to generate torque to cause rotation of screw 48. Actuator motor 54 may also act as a regenerative brake for screw 48 and lift 16 as screw 48 is retracted and lift 16 is lowered with actuator motor 54 converting the kinetic energy of the lift 16 into potential energy that may be stored in power source 18. Actuator motor 54 comprises an electric motor such as an alternating current motor with a stator and rotor or a brushed or brushless direct current motor. Actuator motor 54 may receive current from power source 18 and may be controlled by controller 30.

Gear train 56 is provided to transfer torque output by actuator motor 54 to screw 48. Gear train 56 includes at least one gear coupled to an output shaft of actuator motor 54 and one gear coupled to screw 48. It should be understood, however, that the number and configuration of the gears in gear train 58 may vary depending on the components, operations and capabilities of actuator 26. It should also be understood that actuator 26 may employ a belt drive or other mechanism for torque transfer as an alternative to gear train 56.

Actuator brake 58 provides a parking or emergency brake for actuator motor 54 that is applied to inhibit movement of actuator motor 54, gear train 56, screw 48, nut 50, rod 70 and lift 16 under various operating conditions. Actuator brake 58 may be controlled by controller 30 and may comprise a spring-set, electromechanically released brake that function as an emergency or parking brake. Brake 58 may, for example, include a friction plate coupled to a shaft of motor 54 and configured for rotation with the shaft, an armature that is biased towards engagement with the friction plate by one or more springs to apply the brake 58 and an electromagnet that, when current is provided to the electromagnet, urges the armature away from the friction plate against the biasing force of the springs to release the brake 58. One of both of the friction plate and armature may include a brake pad made from conventional friction materials. Although an exemplary spring-set, electromagnetically release brake has been described above, in should again be understood that brake 58 may assume a variety of forms including, for example, electromagnetically set, spring-released brakes and brakes employing permanent or residual magnetism to apply and/or release the brake—each of which may be used to implement proportional or service braking of motor 54 as an alternative to, or in addition to, emergency or parking brake functionality.

Current sensor 60A provides one means for generating a signal indicative of the weight of a load on lift 16. Current sensor 60A is provided to determine the level of current required by actuator motor 54. Although current sensor 60A is illustrated as a separate element that transmits a signal to controller 30, it should be understood that sensor 60A may form a part of controller 30. In accordance with one aspect of the present teachings, current sensor 60A determines the level of current required by actuator motor 54 as an indication of the weight of the load on lift 16. In particular, the amount of torque required to move lift 16 will, in part, be dependent on the weight of the load on lift 16. Because the amount of torque generated by actuator motor 54 is proportional to the current in actuator motor 54, the current level will be indicative of the weight of the load on lift 16. Baseline or calibration measurements can be obtained before use of device 10 of the current required by actuator motor 54 to raise an unloaded lift 16.

In alternative embodiments actuator 26 may include other means for generating a signal indicative of the weight of a load on lift 16. In one embodiment, actuator 26 may include a linear displacement sensor 60B such as a Hall effect sensor that detects displacement of a component of actuator 26 resulting from compression of one or more elastic members in actuator 26. Actuator 26 may include elastic members such as spring washers of Bellville springs located between a mounting point for actuator 26 and one of the load transmitting components in the actuator 26 such as screw 48. Referring to FIG. 2, for example, spring washers or Belleville springs may be disposed about screw 48 and axis 68 between a fixed mounting point for actuator 26 (e.g., the end of actuator 26 opposite rod 70) and a member of gear train 56. When actuator 26 lifts the load, the elastic members are compressed and the linear displacement of screw 48 along axis 68 is indicative of the weight of the load. The linear displacement sensor 60B measures the displacement of screw 48 and generates a signal to controller 30 indicative of the weight of the load. In another embodiment, actuator 26 may include a deformation sensor 60C such as a strain gauge, piezoelectric sensor or capacitive sensor that detects deformation and displacement of housing member 64 of actuator 26. A portion of housing member 64 is used to attach actuator 26 to lift 16 and is designed to deform under load. A deformation sensor 60C measures the deformation or displacement of this portion of housing member 64 an generates a signal to controller 30 indicative of the weight of the load. The linear displacement sensor 60B and deformation sensor 60C provide the ability to measure both static and dynamic loads on lift 16.

Referring again to FIG. 1, operator interface 28 provides a means for an operator to control device 10, to enter information to, and receive information from, controllers 30 and to receive information from sensors such as speed sensor 24 and position sensors 52 as well as current sensor 60A, linear displacement sensor 60B and deformation sensor 60C used to generate an indication of the weight of the load on lift 16. Interface 28 may include a variety of mechanical and electro-mechanical devices allowing the operator to perform various operations associated with device 10 including activation/deactivation of device 10, steering, operation of lift 16, etc. Interface 28 may further include various input devices such as a keyboard, joystick, or touch screen to allow the operator to enter information for use by controller 30. Interface 28 may also include various output devices such as display screens, speakers, or haptic feedback devices that may be used to convey information to the operator including the speed of device 10, the position of lift 16, and the weight of the load on lift 16. In accordance with one aspect of the present teachings discussed in greater detail below, interface 28 may further provide an indication of the amount of wear on components in device 10 including drive motor brakes 22.

Controller 30 provides a means for controlling the operation of drive motors 20, drive motor brakes 22 and linear actuators 26. Controller 30 may comprise a programmable microprocessor or microcontroller or may comprise an application specific integrated circuit (ASIC). Controller 30 may include a memory 72 and a central processing unit (CPU) 74. Controller 30 may also include an input/output (I/O) interface 76 including a plurality of input/output pins or terminals through which controller 30 may receive a plurality of input signals and transmit a plurality of output signals. The input signals may include signals received from speed sensor 24, operator interface 28, position sensors 52, and sensors 60A, 60B, 60C used to generate an indication of the weight of the load on lift 16 while the output signals may include signals transmitted to drive motors 20, drive motor brakes 22, actuators 26, and operator interface 28.

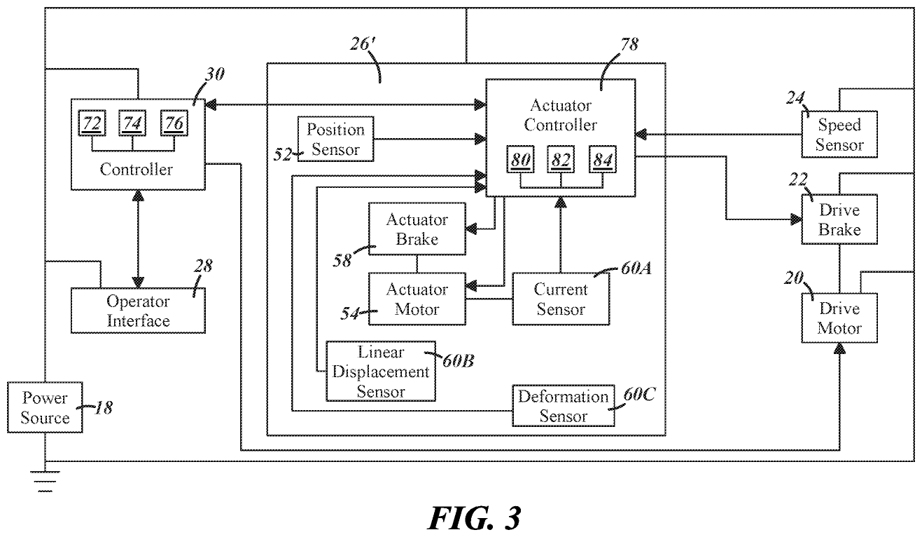

In the illustrated embodiment, a single controller 30 controls the operation of drive motors 20, drive motor brakes 22 and linear actuators 26. Referring to FIG. 3, in an alternative embodiment, these control operations may be divided among multiple controllers. In particular, a linear actuator 26′ may include a separate actuator controller 78. Like controller 30, controller 78 may comprise a programmable microprocessor or microcontroller and may comprise an application specific integrated circuit (ASIC). Like controller 30, controller 78 may also include a memory 80 and a central processing unit (CPU) 82 and an input/output (I/O) interface 84 including a plurality of input/output pins or terminals through which controller 78 may receive a plurality of input signals and transmit a plurality of output signals. In the illustrated embodiment, the input signals may include signals received from speed sensor 24, controller 30, position sensor 52 and sensors 60A, 60B, 60C used to generate an indication of the weight of the load on lift 16 while the output signals may include signals transmitted to drive motor brakes 22, actuator motor 54 and actuator brake 58. Controller 78 is provided for use in controlling components of actuator 26′ including actuator motor 54 and actuator brake 58. Controller 78 may also, however, assume some of the functionality of controller 30 described above including control of movement and braking in device 10 through control of drive motors 20 and/or drive motor brakes 22. In the illustrated embodiment, for example, controller 78 is configured to control braking in device 10 through control of drive motor brakes 22 (while controller 30 continues to control drive motors 20). In this regard, the embodiment shown in FIG. 3 is adapted for modification of existing devices 10 to add the braking control functionality described herein. In accordance with the present teachings, controller 78 may generate control signals for drive motor brakes 22 responsive, in part, to the level of current required by actuator motor 54 as measured by current sensor 60A (which again may form a part of controller 78), linear displacement sensor 60B and/or deformation sensor 60C used to generate an indication of the weight of the load on lift 16. Controller 78 may further generate control signals for drive motor brakes 22 responsive to a combination of inputs including two or more of a braking command input by the operator through interface 28 and received by controller 78 from controller 30, the speed of wheels 14 and device 10 as indicated by a speed signal generated by speed sensor 24 and the weight of the load on lift 16 as indicated by the level of current required by actuator motor 54 responsive to a signal generated by current sensor 60A, the displacement of screw 48 in actuator 26 responsive to a signal generated by linear displacement sensor 60B, or the deformation or displacement of a portion of housing member 64 responsive to a signal generated by deformation sensor 60C.

In accordance with the present teachings, controller 30 (in the embodiment illustrated in FIGS. 1-2) and/or controllers 30 and 78 (in the embodiment illustrated in FIG. 3) may be configured with appropriate programming instructions (i.e., software or a computer program) to implement several steps in a method for controlling mobile lift device 10. A method in accordance with the present teachings may begin with the step of receiving a brake command. In particular, controller 30 may receive a request to brake wheels 14 from an operator through operator interface 28 or from an automated emergency braking system in device 10. The method may continue with the step of determining the weight of the load on lift 16. As discussed above, in one embodiment the system may determine the weight of the load on lift 16 responsive to the current requirements of actuator motor 54. In particular, the weight of the load on lift 16 can be inferred from the level of current required by actuator motor 54 to move the load on lift 16. The level of current required by actuator motor 54 is proportional to the torque required to move gear train 56, screw 48, nut 50, rod 70 and lift 16 and the torque required to move these components is indicative of the weight of the load. Controller 30 or controller 78 may determine the weight of the load on lift 16 responsive to a signal generated by current sensor 60A. If lift 16 is being moved at the time the brake command is received and actuator motor 54 is drawing current, controller 30 or controller 78 may determine the weight of the load based on a contemporaneous signal from sensor 60A indicative of that current. If, however, lift 16 is stationary at the time the brake command is received and actuator motor 54 is not drawing current, controller 30 or controller 78 may determine the weight of the load based on a value in memory 72 or 80 indicative of the current in actuator motor 54 when lift 16 was most recently in motion and obtained from a signal generated by sensor 60A prior to the braking command. As discussed above, in alternative embodiments controller 30 and/or controller 78 may also determine the weight of the load on lift 16 responsive to signals generated by a linear displacement sensor 60B measuring the displacement of screw 48 in actuator 26 or deformation sensor 60C measuring the deformation or displacement of a portion of housing member 64. The method may continue with the step of controlling at least one of drive motor 20 and drive motor brake 22 responsive to the weight of the load on lift 16. Controllers 30, 78 may generate control signals to drive motor 20 to implement regenerative braking of wheel brakes 14 and/or signals to drive motor brakes 22. The selection of drive motor 20 and/or drive motor brake 22 and the amount of braking torque generated by drive motor 20 and drive motor brake 22 is related to the weight of the load on lift 16. In this manner, controllers 30, 78 can vary braking torque based on the load instead of applying a default braking torque that is established to prevent a worst-case scenario such as load having a maximum allowed weight and which may result in a loss of control of device 10 during braking when device 10 is not carrying loads or is carrying loads with lower weights.

In the above-described embodiments, controller 30 and/or controller 78 determines the weight of the load based on a signal from current sensor 60A (or a value in memory 72 or 80), a linear displacement sensor 60B or a deformation sensor 60C after receiving a brake command. In certain embodiments, however, controller 30 and/or controller 78 may generate control signals for drive motor brakes 22 that preset brakes 22 to apply a particular torque whenever a subsequently issued braking command is received (e.g., from automated emergency braking system in device 10 upon a loss of power in device 10). Controller 30 and/or controller 78 may generate the control signals to motor brakes 22 at any point in time responsive to signals from sensor 60A (and/or values in memory 72 or 80), the linear displacement sensor 60B or deformation sensor 60C to preset the applied torque of the motor brakes 22.

Controllers 30, 78 may further be configured to consider other factors in controlling drive motor 20 and/or wheel brakes 22. For example, controller 30 and/or controller 78 may be configured to control drive motor 20 and/or wheel brakes 22 in response to the weight of the load (e.g., as indicated by the level of current required by actuator motor 54, the displacement of screw 48 of actuator 26 or the deformation or displacement of housing member 64) and the speed of wheels 14 as indicated by speed sensor 24. In particular, controller 30 and/or controller 78 may be configured to increase the braking torque applied by drive motor 20 and/or wheel brakes 22 when device 10 is moving relatively fast and reduce the braking torque when device 10 is moving relatively slow. Controller 30 and/or controller 78 may also be configured to control drive motor 20 and/or wheel brakes 22 in response to the weight of the load and the height of lift 16. In particular, controller 30 and/or controller 78 may be configured to increase the braking torque applied by drive motor 20 and/or wheel brakes 22 when lift 16 is at a relatively low position (and there is a reduced risk that device 10 will tip) and to decrease the braking torque when lift 16 is a relatively high position. Controller 30 and/or controller 78 may also be configured to control drive motor 20 and/or wheel brakes 22 in response to the weight of the load and the direction of travel of device 10. In particular, controller 30 and/or controller 78 may be configured to increase or decrease the braking torque applied by drive motor 20 and/or wheel brakes 22 based on the direction of travel depending on the type of device 10 and the center of gravity of device 10. Although the speed of device 10, the height of lift 16 and direction of travel of vehicle 10 have been described alternatively, it should be understood that any combination of these factors may be used (e.g., with appropriate weighting) together with the weight of the load to determine proper control of drive motor 20 and/or wheel brakes 22.

Controller 30 and/or controller 78 may further be configured to use the weight of the load to perform other functions aside from controlling drive motor 20 and/or wheel brakes 22. For example, in accordance with certain embodiments, controller 30 and/or controller 78 may establish values for various control parameters for device 10 responsive to the weight of the load. These parameter values may, for example, include a maximum speed for device 10, a minimum turn radius for device 10, a maximum allowed height for lift 16 or other values. In accordance with certain embodiments, controller 30 and/or controller 78 may generate and provide information on the operation of device 10 responsive to the weight of the load. For example, in accordance with one embodiment, controller 30 and/or controller 78 may determine an amount of wear in a component of device 10 such as drive motor 20 or drive motor brake 22 responsive to the weight of the load. For example, the wear on friction components of drive motor brake 22 is related to the amount of energy dissipated in brake 22 during a braking event. The amount of energy dissipated in brake 22 is dependent on the speed of device 10 and the mass of device 10. The speed of device 10 can be obtained from speed sensor 24. The mass of device 10 can be obtained from a combination of a stored value indicative of the unloaded weight of device 10 and the measured weight of the load on device 10. Using these values, controller 30 and/or controller 78 can determine the amount of wear on the friction components of brake 22. Controller 30 and/or controller 78 may use this information in a variety of ways including in the control of drive motors 20 and drive brakes 22, establishing operating parameter values for motors 20 and drive brakes 22 and to generate an indication of the amount of wear to either or both of an operator of device 10 through, for example, operator interface 28, and a centralized management system for device 10 through, for example, wireless transmission of a signal indicative of the amount of wear (e.g., for the purpose of predictive maintenance).

A mobile lift device 10 and control system for a brake of the mobile lift device 10 in accordance with the present teachings is advantageous relative to conventional mobile lift devices and brake control systems. In particular, the inventive lift device 10 and brake control system uses a signal generated by the electromechanical linear actuator 26 as an indicator of the weight of the load in order to provide improved control of braking for the driven wheel 14 of the mobile lift device 10. As a result, the braking torque can be varied based on the load and improved control of the mobile lift device during braking is obtained.

While the invention has been shown and described with reference to one or more particular embodiments thereof, it will be understood by those of skill in the art that various changes and modifications can be made without departing from the spirit and scope of the invention.

I claim:

1. A mobile lift device, comprising:
a body supported on a driven wheel;
a lift supported by the body and configured for vertical movement relative to the body, the lift configured to support a load;
an electric drive motor configured to cause rotation of the driven wheel;
a drive motor brake coupled to the electric drive motor;
an electromechanical linear actuator configured to raise and lower the lift, the electromechanical linear actuator including an electric actuator motor; and,
a controller configured to
determine a weight of the load responsive to a signal generated by the electromechanical linear actuator; and,
control at least one of the electric drive motor and the drive motor brake responsive to the weight of the load.

2. The mobile lift device of claim 1 wherein the controller is further configured, in determining the weight of the load, to determine a level of current required by the electric actuator motor of the electromechanical linear actuator, the level of current indicative of the weight of the load.

3. The mobile lift device of claim 1 wherein the controller is further configured, in determining the weight of the load, to determine a linear displacement of a component of the electromechanical linear actuator, the linear displacement indicative of the weight of the load.

4. The mobile lift device of claim 1 wherein the controller is further configured, in determining the weight of the load, to determine an amount of deformation of a component of the electromechanical linear actuator, the amount of deformation indicative of the weight of the load.

5. The mobile lift device of claim 1 wherein the electromechanical linear actuator further includes a screw driving a nut coupled to the lift.

6. The mobile lift device of claim 5 wherein the electromechanical linear actuator further includes an actuator brake configured to inhibit movement of the screw and nut when the actuator brake is applied.

7. The mobile lift device of claim 6 wherein the controller is further configured to generate control signals for the electric actuator motor and the actuator brake.

8. The mobile lift device of claim 7, further comprising a position sensor actuated in response to movement of a component of the electromechanical linear actuator, the position sensor configured to generate a signal indicating the component is located at a predetermined position and wherein the controller controls delivery of current to at least one of the electric actuator motor and the actuator brake responsive to the signal.

9. The mobile lift device of claim 1 wherein the electromechanical linear actuator transfers kinetic energy of the lift to a power source as the lift is lowered.

10. The mobile lift device of claim 1, further comprising a speed sensor configured to generate a speed signal indicative of a rotational speed of the driven wheel and wherein the controller is configured to control the at least one of the electric drive motor and the drive motor brake responsive to the weight of the load and the rotational speed of the driven wheel.

11. The mobile lift device of claim 1, wherein the controller is configured to establish a parameter value relating to movement of the mobile lift device responsive to the weight of the load.

12. The mobile lift device of claim 11 wherein the parameter comprises a maximum speed for the mobile lift device.

13. The mobile lift device of claim 11 wherein the parameter comprises a turn radius for the mobile lift device.

14. The mobile lift device of claim 1 wherein the controller is further configured to determine an amount of wear in a friction component of the drive motor brake responsive to the weight of the load.

15. The mobile lift device of claim 14 wherein the controller is further configured to generate an indication of the amount of wear.

16. A system for controlling a mobile lift device, comprising:
an electromechanical linear actuator configured to raise and lower a lift of the mobile lift device, the lift configured to support a load, the electromechanical linear actuator including an electric actuator motor; and,
a controller configured to
determine a weight of the load responsive to a signal generated by the electromechanical linear actuator; and,
control at least one of an electric drive motor configured to cause rotation of a driven wheel of the mobile lift device and a drive motor brake coupled to the electric drive motor responsive to the weight of the load.

17. The system of claim 16 wherein the controller is further configured, in determining the weight of the load, to determine a level of current required by the electric actuator motor of the electromechanical linear actuator, the level of current indicative of the weight of the load.

18. The system of claim 16 wherein the controller is further configured, in determining the weight of the load, to determine a linear displacement of a component of the electromechanical linear actuator, the linear displacement indicative of the weight of the load.

19. The system of claim 16 wherein the controller is further configured, in determining the weight of the load, to determine an amount of deformation of a component of the electromechanical linear actuator, the amount of deformation indicative of the weight of the load.

20. The system of claim 16, further comprising a speed sensor configured to generate a speed signal indicative of a rotational speed of the driven wheel and wherein the controller is configured to control the at least one of the electric drive motor and the drive motor brake responsive to the weight of the load and the rotational speed of the driven wheel.

21. The mobile lift device of claim 16 wherein the controller is configured to establish a parameter value relating to movement of the mobile lift device responsive to the weight of the load.

22. The mobile lift device of claim 21 wherein the parameter comprises a maximum speed for the mobile lift device.

23. The mobile lift device of claim 21 wherein the parameter comprises a turn radius for the mobile lift device.

24. The mobile lift device of claim 16 wherein the controller is further configured to determine an amount of wear in a friction component of the drive motor brake responsive to the weight of the load.
